(19) United States
(12) Patent Application Publication
(10) Pub. No.: US 2007/0233460 A1
(43) Pub. Date: Oct. 4, 2007

(54) Computer-Implemented Method for Use in a Translation System

(75) Inventors: Mark Lancaster, Berkshire (GB); James Marciano, Berkshire (GB); Keith Mills, Berkshire (GB)

Correspondence Address: DAVID E. HUANG, ESQ.;BAINWOOD HUANG & ASSOCIATES LLC, 2 CONNECTOR ROAD, SUITE 2A, WESTBOROUGH, MA, 01581, US

(73) Assignee: SDL plc, Berkshire (GB)

(21) Appl. No.: 11/659,858

(22) PCT Filed: Aug. 11, 2005
(86) PCT No.: PCT/GB05/03164

§ 371 Date: May 14, 2007

(30) Foreign Application Priority Data
Aug. 11, 2004 (GB) 0417882.8

(51) Int. Cl. G06F 17/27

(52) U.S. Cl. 704/9

(57) ABSTRACT

A computer-implemented method for use in natural language translation. The method involves attaching pieces of linguistic information to two or more source language elements in a source material in a first natural language. The pieces of linguistic information are matched to one or more predetermined parse rules. Associations are then formed between the two or more source language elements to form terminology candidates, which are then presented to human reviewers. Terminology candidates are subsequently validated by a user, becoming validated terminology which is then translated into a second, different, natural language, becoming translated terminology. The translated terminology can then be loaded into a machine-translation dictionary which can be used during subsequent machine-assisted translations.

### FIELD OF THE INVENTION

This invention relates to a computer-implemented method, computer software and apparatus for use in natural language translation.

### BACKGROUND OF THE INVENTION

Many organisations whose trade extends abroad desire documentation in numerous languages in order to provide the greatest possible coverage in the international marketplace. Modern communication systems such as the Internet and satellite networks span almost every corner of the globe and require ever increasing amounts of high-quality natural translation work in order to achieve full understanding between a myriad of different cultures.

As rule of thumb, an expert human translator can translate approximately 300 words per hour, although this figure may vary according to the difficulties encountered with a particular language-pair. It may be possible to translate more than this figure for a language-pair with similar grammatical structure and vocabulary such as Spanish-Italian, whereas the case may be the opposite for a language-pair with little commonality such as Chinese-English. It would take a huge amount of manpower alone to cope with all the global translation needs of modern-day life. Clearly some assistance for the translators is needed in order for them to even begin to keep up with constantly evolving requirements and updates for countless web-pages, company brochures, government documents, and press articles, to name but a few areas of application.

With the ability to process vast amounts of information, computers naturally lend themselves to tackling the problem by way of machine translation. In the early days of computer-automated translation, known as machine translation, attempts were made to translate directly from a source to a target language by the use of dictionaries. Such dictionaries were vast and became unwieldy with multiple source-target language pairs. To be utilised efficiently and reliably, such dictionaries required comprehensive sets of syntactic and grammatical rules.

Various pure machine translators exist which can translate many thousands of words in a matter of seconds, but the success rates cannot be guaranteed. An example of a company using this approach and supplying free web versions is Systran S.A., whose machine-translation technology powers the Babelfish website, hosted by Altavista (http://babelfish.altavista.com/).

A human influence is used somewhere in the machine translation process to provide the desired level of translation. One approach by Caterpillar Inc., is the subject of International Patent Application WO 94/06086, where various lexical and grammatical constraints are applied to the source via an interactive text editor. This allows simplified rules to be applied through the translation algorithm and helps to disambiguate the translated text. Although no post-editing is necessary, this system is not ideal as the very process of limiting the input source language requires human intervention via a series of confirmatory questions.

A segmentation and merging method for use in machine translation is described in International Patent Application WO 02/29621. The task of the translator is simplified by giving the translator greater flexibility in how to translate content before actually performing the translation. The user may merge or split the content according to certain formatting or lexical characteristics.

A system specifically tailored to translate computer software for international distribution is detailed in European Patent Application EP 0668558. Here various different tools are implemented via a graphical user interface (GUI) such as a localisation tool, a glossary tool and a build tool to aid in the conversion. Accompanied by a binary copy of the software program in question, these tools allow a local software distributor to create versions of foreign programs that can be understood and used under licence from the original software house.

Bridging the gap between purely human and purely machine translation are machine-assisted translation methods where the burden can be shared between human and computer.

In International PCT Application WO 99/57651, a system is described that recognises certain parts of sentences that do not need any translation or merely simple formulaic conversions such as dates, times, titles, names and numbers. The idea is to assist translators by not having them retype information that does not need their attention. The translators are then free to direct their full attention to other parts-of-speech such as verbs, adjectives etc., thus making the use of their skills more efficient.

A number of patents cover the area of statistical natural language translation. These systems can operate without human assistance or in tandem with a human user. An example of the former case is described in U.S. Pat. No. 5,991,710 where conditional probability metrics are used to produce a source language model. To translate a document, the system then picks out the closest candidate according to the model.

An example of the latter case is given in U.S. Pat. No. 5,768,603 where statistical metrics are created through the scanning of a document aligned in the relevant language-pair. Once trained, the system calculates the most likely translation candidates for the unaligned document in question. These candidates are then presented to a human translator/editor who chooses the best translation for each situation. Clearly, such systems merely produce results as good as the probability models or input training sets that form their basis.

There is thus a need for a quick, efficient, easy-to-use and reliable machine-assisted natural language translation system, which will take account of the linguistics of the source input language.

### SUMMARY OF THE INVENTION

In accordance with a first aspect of the present invention, there is provided a computer-implemented method for use in natural language translation, said method comprising performing, in a software process, the steps of:

selecting at least a part of source materials in a first natural language;

selecting a first source language element from said part;

selecting a second, different, source language element from said part;

attaching at least a first piece of linguistic information to said first source language element;

attaching at least a second piece of linguistic information to said second source language element;

matching said first and second pieces of linguistic information to at least a first parse rule;

forming an association between said first and second source language elements in response to said matching to create a first terminology candidate; and

outputting said first terminology candidate in a form suitable for review by a human reviewer prior to full translation of said source materials in said first natural language to at least a second natural language.

Hence, by use of the present invention, a software process can identify terminology candidates by matching linguistic information in a source text with linguistic patterns defined in predetermined parse rules. This linguistic information may include part-of-speech information indicating that a source language element is a verb or a noun, for example.

Preferably, the terminology candidates will subsequently be validated by a user, becoming validated terminology. The validated terminology is then translated into a second, different, natural language, becoming translated terminology. The translated terminology can then be loaded into a machine-translation dictionary used during subsequent machine-assisted translation, to be applied to the source materials as a whole. Wherever the terminology candidate appears, the correct translation is thus immediately available, and no further human input is required to obtain the correct translation.

In accordance with a second aspect of the present invention, there is provided computer software arranged to perform the steps described in the first aspect.

Hence, by use of the present invention, the extraction of terminology candidates from a source text can be facilitated by operating software loaded and running on a suitable computational device.

In accordance with a third aspect of the present invention, there is provided apparatus for computer-assisted natural language translation comprising:

an information storage system adapted to store digital content, said content including source materials in a first natural language, a plurality of pieces of linguistic information and their associations to source language elements, a plurality of parse rules, a plurality of terminology candidates, a set of validated terminology and a set of translated terminology;

an information processing system adapted to provide a means for determining instances of source language elements, executing parse rules and the process of attaching pieces of linguistic information to source language elements;

a data entry system adapted to provide a means for entering selection data relating to said content, wherein said selection data includes data indicating the validation of terminology candidates; and

a visual display system adapted to present information from the information storage system, said presentation information including data in the form of said source materials, said source elements, said plurality of terminology candidates, said set of validated terminology and said set of translated terminology.

Hence, by use of the present invention, it is possible to extract a plurality of terminology candidates from a source text via a computing system with an information storage system, an information processing system, a data entry system and a visual display system.

In accordance with a fourth aspect of the present invention, there is provided a computer-implemented method for use in natural language translation, said method comprising performing, in a software process, the steps of:

selecting at least a part of source materials in a first natural language;

selecting a first source language element from said part;

selecting a second, different, source language element from said part;

matching said first and second source language elements to at least a first parse rule, said first parse rule requiring said first and/or second source language elements to have a predetermined characteristic;

forming an association between said first and second source language elements in response to said matching to create a first terminology candidate; and

outputting said first terminology candidate in a form suitable for review by a human reviewer prior to full translation of said source materials in said first natural language to at least a second natural language.

Hence, by use of the present invention, a software process can identify terminology candidates by predetermined characteristics in a source text with predetermined characteristics present in certain previously known parse rules. These predetermined characteristics may include capitalisations or hyphenations or other such punctuation.

Preferably, the terminology candidates will subsequently be validated by a user and translated into a second, different, natural language. The translated terminology can then be loaded into a machine translation dictionary used during subsequent machine assisted translation, to be applied to the source materials as a whole. Wherever the terminology candidate appears, the correct translation is thus immediately available, and no further human input is required to obtain the correct translation.

In accordance with a fifth aspect of the present invention there is provided a computer-assisted method for use in natural language translation, said method comprising performing, in a software process, the steps of:

identifying a set of terminology candidates in at least a part of source materials in a first natural language;

presenting said set of terminology candidates to a user via a user interface; and

receiving selection data from said user, said selection data being used to create a subset of said terminology candidates to generate a set of validated terminology.

Hence by use of the present invention, a user can be presented with a set of terminology candidates identified by a computing system from a source text in a first natural language and subsequently select a subset of validated terminology.

Preferably, the validated terminology would then be translated into a second, different, natural language. The translated terminology can then be loaded into a machine-translation dictionary used during subsequent machine assisted translation, to be applied to the source materials as a whole. Wherever the terminology candidate appears, the correct translation is thus immediately available, and no further human input is required to obtain the correct translation.

In accordance with a sixth aspect of the present invention there is provided a computer-implemented method for use in natural language translation, said method comprising performing, in a software process, the steps of:

loading at least a part of source materials in a first natural language;

selecting a first parse rule;

using said first parse rule to identify one or more terminology candidates in said part;

outputting said one or more identified terminology candidates;

selecting a second parse rule;

using said second parse rule to identify one or more further terminology candidates in said part; and

outputting said one or more further identified terminology candidates.

Hence, by use of the present invention, a software process can identify terminology candidates by using one or more parse rules to scan a source text in a first natural language. The output from one parse rule could be used as the input to another.

Preferably, the terminology candidates will subsequently be translated into a second, different, natural language. The translated terminology can then be loaded into a machine-translation dictionary used during subsequent machine assisted translation, to be applied to the source materials as a whole. Wherever the terminology candidate appears, the correct translation is thus immediately available, and no further human input is required to obtain the correct translation.

The present invention draws on some of the features of the prior art described in the previous section, improves on some of their drawbacks and proposes a quick, efficient, easy-to-use and reliable machine-assisted natural language translation method and system.

The present invention acknowledges the fact that computers often cannot produce perfect translations. The present invention utilises the fundamentals of the structure of the language in question and is able to identify terminology candidates more efficiently. The automation of some of the more laborious steps of the translation process leads to significant reductions in labour time and costs associated with machine-assisted translation.

The present invention also acknowledges, and uses to its advantage, the fact that a human input sometimes remains the best way to find an acceptable translation for a terminology candidate due to the highly intricate structure of human languages. This process is facilitated by providing an efficient human-to-computer interface, across which such steps can be taken prior to conducting a full machine-assisted translation. With the assistance of the present invention, it is possible for an expert human translator to translate, to the same standard, up to four times as fast as an expert human translator alone.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 is a logical-view system diagram according to the preferred embodiment of the invention.

FIG. 2 is a physical-view system diagram according to an embodiment of the invention.

FIG. 3 is diagram showing the software components according to an embodiment of the invention.

FIG. 4 is a high-level flow diagram showing the terminology candidate extraction process according to an embodiment of the invention.

FIG. 5 is a flow diagram of the steps involved in the initial setup stage according to an embodiment of the invention.

FIG. 6 is a flow diagram of the steps involved in the word analysis process according to an embodiment of the invention.

FIG. 7 is a flow diagram of the steps involved in the first half of the terminology candidate parsing process according to an embodiment of the invention.

FIG. 8 is a flow diagram of the steps involved in the second half of the terminology candidate parsing process according to an embodiment of the invention.

FIG. 9 is a flow diagram of the steps involved in the export process according to an embodiment of the invention.

FIG. 10 is a screenshot of the root form view of a list of terminology candidates, ordered by frequency of occurrence in descending order and some display option icons according to an embodiment of the invention.

FIG. 11 is a screenshot of the inflected form view of a list of terminology candidates in ascending alphabetical order according to an embodiment of the invention.

FIG. 12 is a screenshot of the inflected form word view in ascending alphabetical order according to an embodiment of the invention.

FIG. 13 is a screenshot of the root form word view in ascending alphabetical order according to an embodiment of the invention.

FIG. 14 is a screenshot of some terminology candidates, with a second window for displaying translations of these terminology candidates and a terminology candidate with a corresponding translation that has been reviewed and validated according to an embodiment of the invention.

FIG. 15 is a screenshot showing a bad terminology candidate being removed from a list of terminology candidates according to an embodiment of the invention.

### DETAILED DESCRIPTION OF THE INVENTION

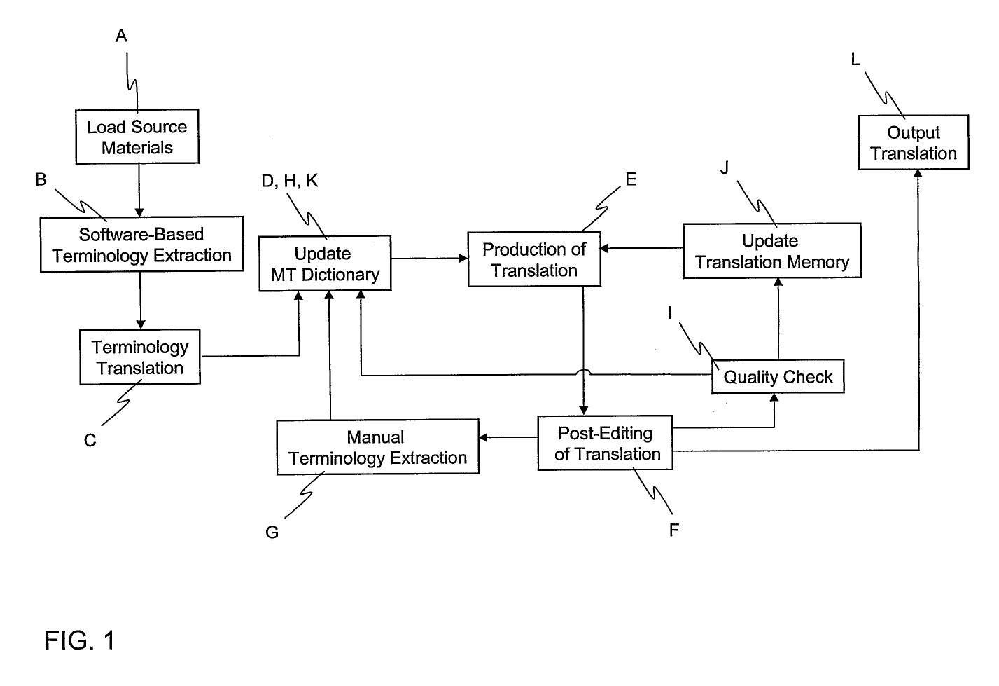

A logical-view system diagram of the invention is shown in FIG. 1. In step A, the source materials are loaded and the software-based terminology extraction process shown in step B is carried out. In step C, the terminology is translated and a machine-translation dictionary is updated with this new data in step D. The new data is used to produce a translation in step E, with input from a previously known set of translations from a translation memory.

A post-editing translation process occurs in step F where the translations are checked by a translator. The translator may also manually extract terminology as shown in step G and the results are used to update the machine-translation dictionary again in step H. In step I, a quality check of the translations is carried out by a translator or computational linguist before the translation memory is updated in step J. Additionally, the quality check may also result in additions to the machine-translation dictionary in step K. The linguist who checks the quality sees the types of changes that the post-editors have made. If there are consistent changes that can be avoided in the future by adding entries to the machine-translation dictionary, those entries are created at this time and applied to any future translations, just as the updated translation memory is applied to future translations. The translations are then ready to be output in the target language in step L.

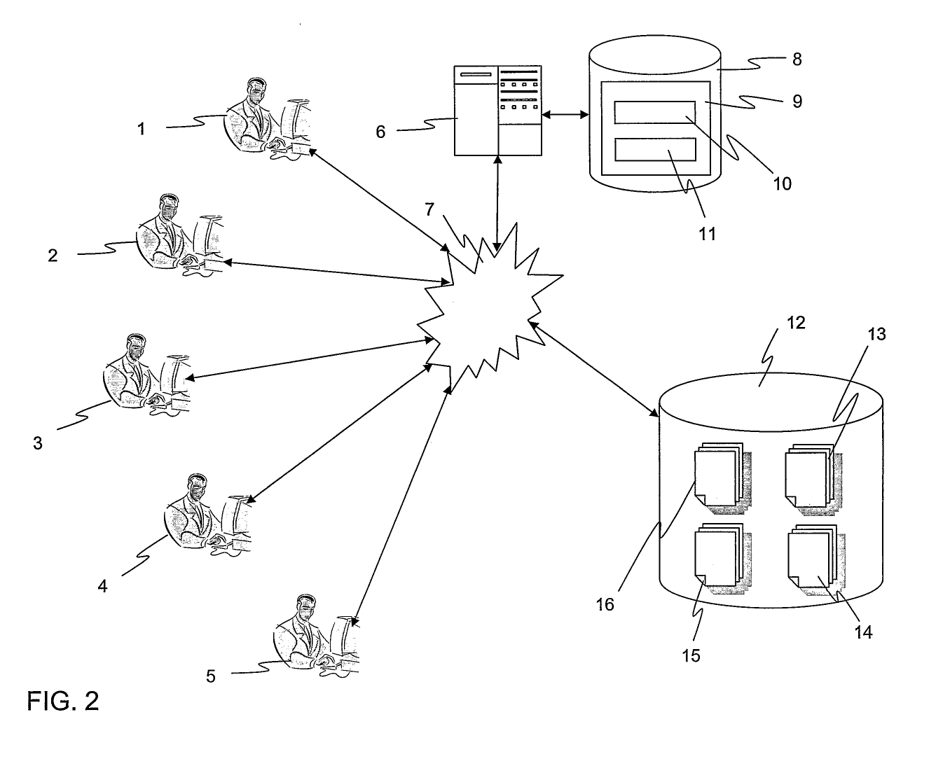

A physical-view system diagram of the invention is shown in FIG. 2. This gives an example of a networked system where the present invention could be applied, but is by no means the only scenario of application. A first database, shown as component 12, is used to store one or more source documents or materials, shown as component 16 in a first natural language for translation into one or more different natural languages. The first database is also used to store translated terminology, shown as component 14 that are ready for output once the translation process is completed. This database is accessible via a plurality of user terminals, whose function will be explained below. The first database is connected to a server, shown as component 6, either locally or remotely across a telecommunications network shown as component 7. The server is responsible for the processing of information relating to the first database and also communicates via the telecommunications network to a plurality of user terminals. A second database, shown as component 8, is connected to the server to hold information relating to the machine-translation dictionary, shown as component 9. This machine-translation dictionary consists of a main dictionary, shown as component 10, which holds words for use in general translation and also possibly a custom dictionary, shown as component 11, which holds words specific to the current subject matter being translated or for a specific client etc.

The user terminals may be personal computers or other computational devices such as a servers or laptops that are capable of processing data. A first user terminal, shown as component 1, runs the software of this invention which analyses one or more of the source documents in order to extract terminology candidates for validation. These terminology candidates, also referred to herein generally as “phrases,” are stored on the first database, shown as component 15. The validation process involves input from a user or trained computational linguist. The user input may involve validation of terminology candidates, deletion of incorrect terminology candidates, insertion of corrected terminology candidates and various other steps which will be explained in more detail below.

Once validated, the terminology candidates form a list of validated terminology, shown as component 13, which are stored on the first database. To translate into a second, different, natural language, a translator operates a second user terminal, shown as component 2, to validate and/or correct translations provided by the software or provide new translations where no translations were provided. To translate into a third, different, natural language, a translator operates a third user terminal, shown as component 3, to validate and/or correct translations provided by the software or provide new translations.

The translators provide lists of translated terminology, shown as component 14, which are stored in the first database. The information from the terminology extraction process is used to create a machine translation dictionary, which can be used in future translations. The server then uses the translated terminology and information stored in the machine-translation dictionary to provide full machine translations of the source documents in the required languages. These machine translations are then verified at further user terminals, shown as components 4 and 5, and are then ready for use by the client of the translating entity. Further translators and verifiers can be used to provide translations in further, different natural languages.

Note that the files mentioned above that are stored in the first and second databases could also be stored in non-database formats such as the well-known SGML and XML formats.

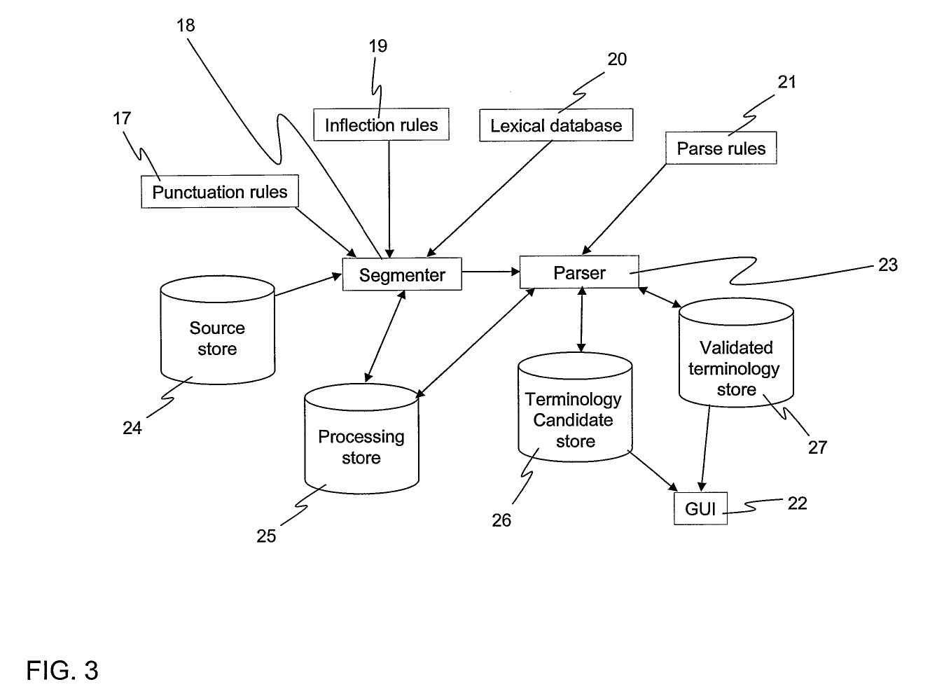

The diagram in FIG. 3 shows the software components of the present invention. A source store, shown as component 24, is used to hold the text from the source documents. The source store is accessed by a segmenter, shown as component 18, which divides the source text up into sentences and words. The segmenter has access to a set of previously defined punctuation rules, shown as component 17, and a set of previously defined inflection rules, shown as component 19. Use is also made of information stored in the lexical database, shown as component 20. The segmentation information is held on the processing store, shown as component 25 and a parser, shown as component 23 is then enabled to parse the text. Parsing is the term used here to describe the manner in which the text is scanned or processed in order to extract terminology candidates. The processor store also holds a number of data objects that are used during the running of the software. These data objects include a LANGUAGE object used to store information on the language of the current source, a SENTENCE object used to store information on the sentence currently being parsed, a PHRASE object used to store information on the terminology candidates currently being extracted and a GLOBAL PHRASE object used to store information on the terminology candidates extracted thus far.

The parser component uses a set of parse rules, shown as component 21, to study the construction of the sentences and the relationships between the words therein. A set of parse rules are accessed by the parser for each rule to enable its operation. The parse rules are used to attach various pieces of linguistic information or other predetermined characteristics to one or more source language elements, such as words, in a sentence. A group of words or concatenation of words will be referred to herein as a “multiword.” Further reference herein to source language elements may include words or multiwords as these can also be considered as single source language elements by the parser when applying further parse rules. The parse rules are applied so as to identify terminology candidates matching one or more parse rules. The output of terminology candidates from one parse rule may be used as an input to one or more further parse rules and this recursion or feedback can be used repeatedly to build up further linguistic relationships and hence further extracted terminology candidates.

The linguistic information attached to a source language element may be part-of-speech information, for example the verb part-of-speech or the noun part-of-speech, or inflectional information, such as “noun_reg_s” indicating how the source language element is inflected. Some examples of the predetermined characteristics may be a hyphenated source language element or a capitalisation. If the source language element patterns or ordering are such that they correspond to a parse rule, then they are said to be matched to this parse rule. Once the parser has matched a source language element to a parse rule, a terminology candidate has been extracted and this is stored in the terminology candidate store, shown as component 26. The terminology candidates are then presented via a GUI, shown as component 22, to a computational linguist for validation. Once validated, these terminology candidates are stored in a validated terminology store, shown as component 27, for presentation to a translator.

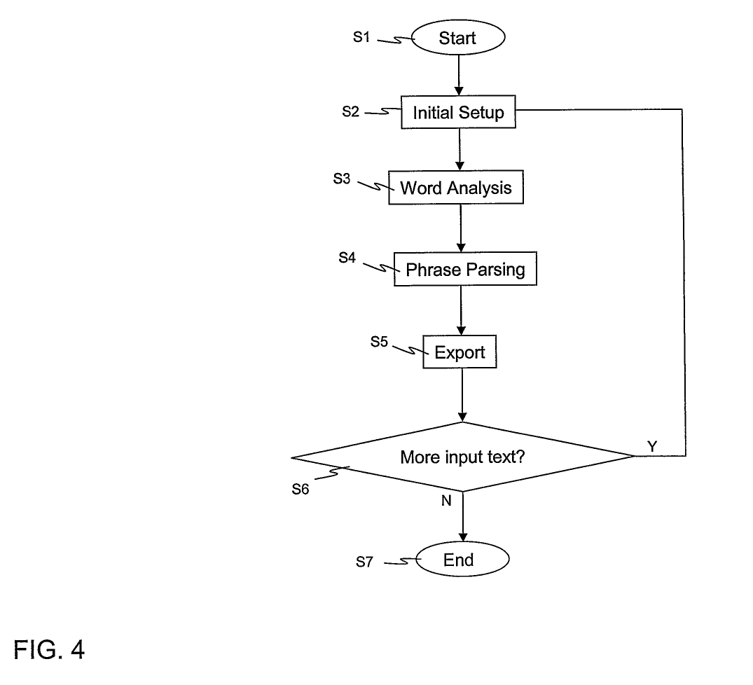

The present invention relates primarily to the software-based terminology extraction process B, but also to the system as a whole. A high-level flow diagram of the terminology-extraction process of the invention is shown in FIG. 4. The process starts with stage S1, when the software for the present invention is run on a computing system, either locally or remotely via an internet or wireless link on a personal computer, laptop computer, personal digital assistant, server or similar setup. The Initial Setup stage S2 involves loading the required source documents and any required reference files. The source text is also segmented into sentences here. The next stage S3 is Word Analysis which involves segmenting the source sentences into source language elements and applying punctuation and inflection rules. Next, the Phrase Parsing stage S4 takes place. This involves scanning the source language elements for each sentence and matching them to various parse rules to produce terminology candidates. The final stage S5 is the Export stage where the terminology candidates are exported into a display format. The software then checks to see if there are further sentences to be analysed in stage S6, and if so the process loops back to the Initial Setup stage S2, otherwise the translation process ends with stage S7.

Initial Setup Stage

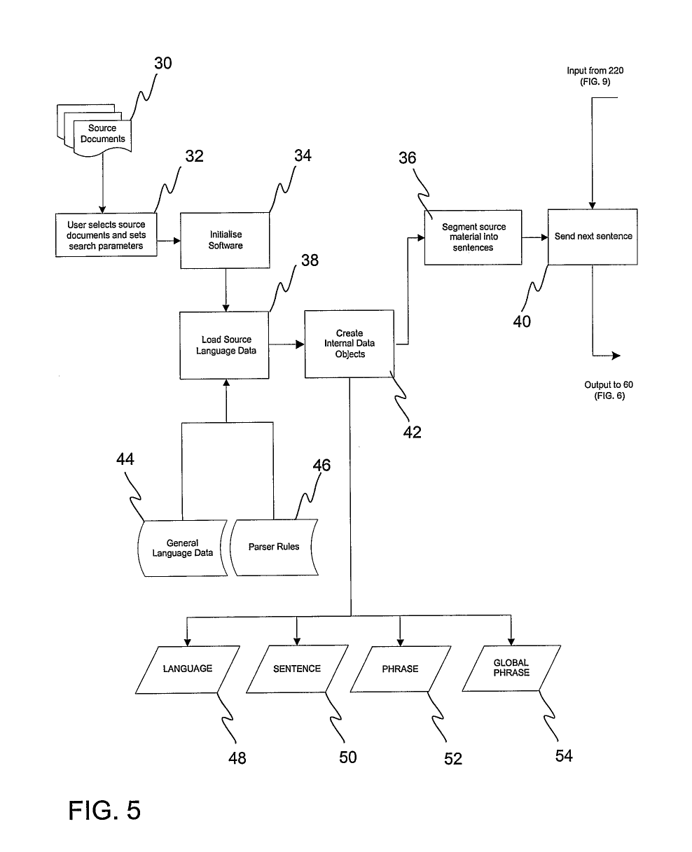

A more detailed view of the Initial Setup stage S2 is given in FIG. 5. The first step of the initial user setup involves one or more source documents, denoted by item 30, being loaded into the software package via a graphical user interface (GUI), denoted by item 32. The second step of the initial user setup involves the user specifying which format the documents are in. The formats may be one or more from a variety of digital computer formats including Rich Text Format (*.rtf), Plain Text (ANSI) format (*.txt), HyperText Markup Language format (*.html) and a number of formats specific to the present invention and related software packages. There is also an option for opening a previously analysed text.

In the third step of the initial user setup, the user has the option to either analyse the whole of each source document, a percentage of each source document, or specify how many of the segments (sentences) from the start of the source document to analyse. The source language is specified and the user can ask the software to provide translations for all found terminology candidates from the lexical database, if available. If such translations are to be provided, the target language can be chosen here also.

In the fourth and final step of the initial user setup, a number of search parameters may be specified by the user as user settings.

User Settings

One user setting allows limiting of the length of terminology candidates extracted by the software. The maximum length is defined in terms of a number of words per terminology candidate. The maximum terminology candidate length defaults to five but can be increased or decreased to suit a particular source text or language-pair.

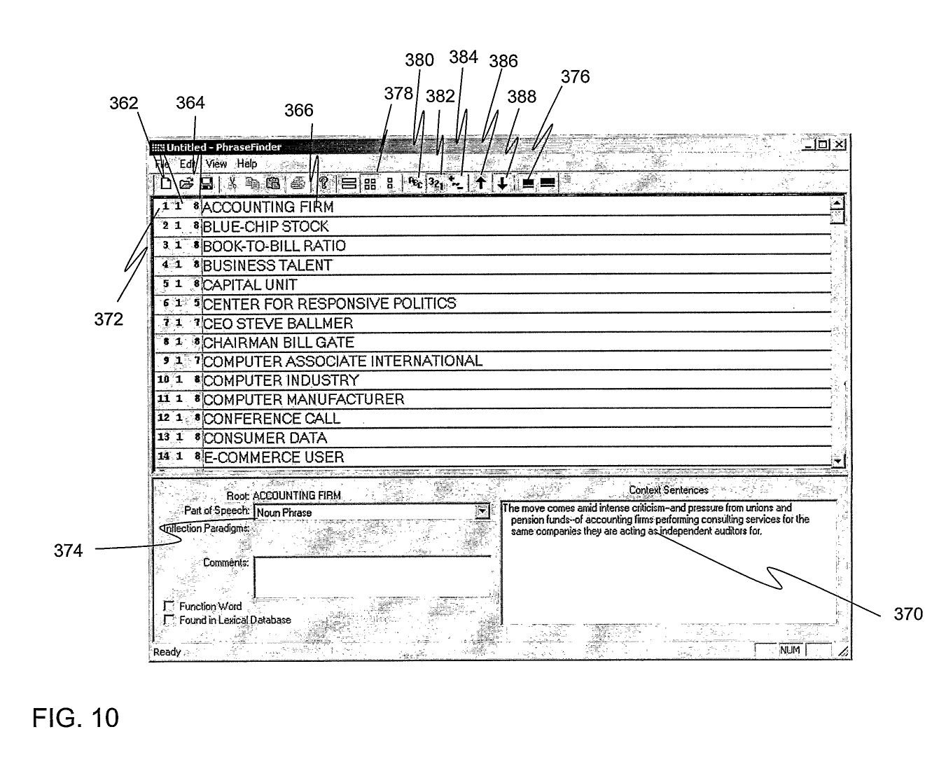

Another user setting allows only a subset of the extracted terminology candidates to be displayed. The subset can be selected by one or more of rank and/or frequency. There are icons to alter the order in which the extracted terminology candidates are displayed. This can be done alphabetically, by frequency or by rank and these icons are shown as items 380, 382 and 384 respectively in the screenshot of FIG. 10. There are also icons to sort in ascending and descending order, which are shown as items 386 and 388. The frequency referred to here is the frequency of occurrence of the terminology candidate in the source text. The numbers in the column indicated by item 372 give the row or order number for each extracted terminology candidate according to the current display mode. The numbers in the column indicated by item 362 give the frequency of occurrence of each extracted terminology candidate in the source document(s). The numbers in the column indicated by item 364 give the rank for each extracted terminology candidate. The way in which this rank is calculated is described in a later section.

Another user setting allows a limit to the number of context sentences presented during validation to be set. By default, no such limit is set and all the sentences where a particular terminology candidate is present in the source text are displayed in the Context Sentences window, shown as item 370 in FIG. 10. The use of this function will be discussed in a later section.

Another user setting allows the bypass of the blocked text function as, by default, the software asks for a blocked word list. The use of this function will be discussed later.

Another user setting instructs the software to ignore function words during the extraction process. A function word is a word that primarily indicates a grammatical relationship and has little semantic content of its own. Articles (the, a, an), prepositions (in, of, on, to) and conjunctions (and, or, but) are all function words. Bypassing function words reduces the number of terminology candidates that are extracted and can, therefore, save considerable time in the validation phase.

Another user setting instructs the software to ignore non-maximal matches during the extraction process. A maximal match indicates the longest possible string that can be parsed as a terminology candidate although it contains shorter collocations that could also be parsed as terminology candidates. A non-maximal match is a multiword that has been extracted as a terminology candidate and is a component of a larger multiword that has also been extracted. For instance, the sentence “The United Kingdom of Great Britain and Northern Ireland includes Scotland and Wales.” yields the maximal terminology candidate “The United Kingdom of Great Britain and Northern Ireland” but also the lesser non-maximal matches “The United Kingdom,” “Great Britain,” and “Northern Ireland.”

Another user setting instructs the software to ignore any numerals during the extraction process.

Another user setting allows any unfound text to be ignored. Unfound text may include words for which the software has been unable to determine the part-of-speech, typographical errors in the source, or words that cannot be found in the lexical database.

Another user setting instructs the software to ignore source language elements with initial capitalisation except at the start of the sentence.

Another user setting instructs the software to ignore all source language elements that appear in all uppercase letters.

Another user setting instructs the software to disregard differing capitalisation in otherwise identical terminology candidates.

A further three user settings allow the user to set a default blocked word list, use the last saved blocked word list specific to the current project and specify the filename for the blocked word list. A blocked word list is a text file that contains source language elements and/or terminology candidates that should not be displayed in the GUI. This allows the user to add previously extracted terminology candidates to the blocked word list so that only newly extracted terminology candidates are presented for validation and translation. Additionally, the user can add words and/or terminology candidates to the blocked word list that have previously been shown to add meaningless data, or “noise,” to the output.

Once all the settings have been specified, the software is initialised in step 34 and the Source Language Data is loaded in step 38. This loading involves reading the General Language Data of item 44 and Parser Rules of item 46, which contain linguistic data specific to the language of the source text currently being scanned. Various internal data storage objects are then created, as shown in step 42, called LANGUAGE, shown as item 48, SENTENCE, shown as item 50, PHRASE, shown as item 52 and GLOBAL PHRASE, shown as item 54. The LANGUAGE object is used to hold language data for the current source language, the SENTENCE object is used to hold data relating to the sentence currently being scanned, the PHRASE object is used to hold data relating to the terminology candidates currently being extracted and the GLOBAL PHRASE object is used to hold data relating to all the terminology candidates scanned thus far for the current project.

Once all the data objects have been created, the source text is segmented into sentences in step 36 and each sentence is passed, as shown in step 40, to the Word Analysis stage of stage S3 in FIG. 4.

Word Analysis Stage

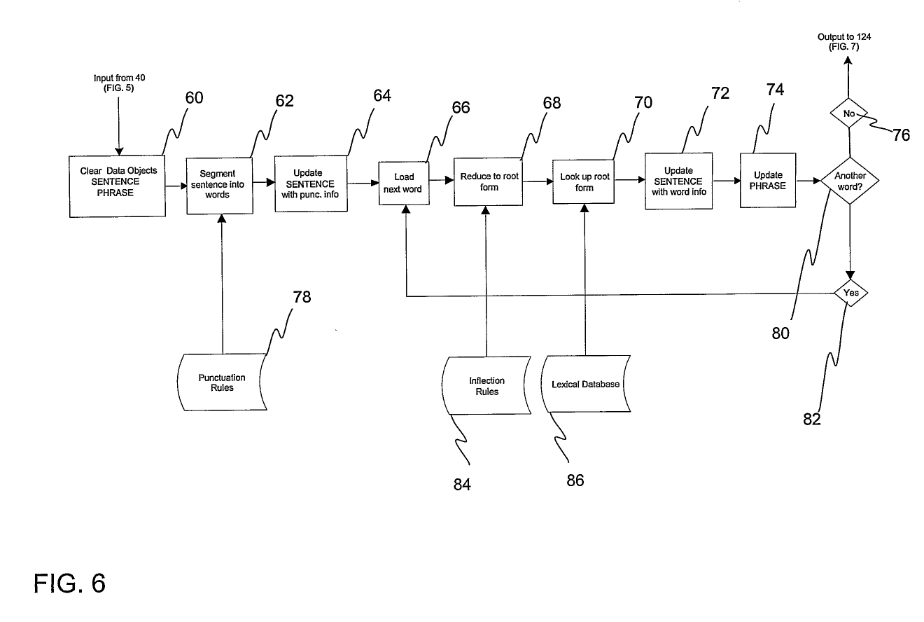

FIG. 6 shows a detailed view of the Word Analysis stage S3. This iterative stage deals with analysing the source language elements in each sentence to find out their type, by employing punctuation and inflection rules and consulting the lexical database. The input from the Send Next Sentence, step 40 of FIG. 5, is shown leading to the Clear Data Objects SENTENCE, PHRASE in step 60 of FIG. 6. This clearing is carried out for each sentence analysed for the first two of these data objects to flush out any old variables or settings from previous iterations.

In step 62, the first sentence is segmented into words, by applying a set of punctuation rules, as shown by item 78. In step 64, the data object SENTENCE is updated with the punctuation information for the current sentence. This punctuation information may include the location of any commas, quotation marks, etc. The first word is then loaded, as shown in step 66, and reduced to root form in step 68 by applying a set of inflection rules, as shown by item 84. The root form is then checked in step 70 by accessing the lexical database, as shown by item 86. The lexical database provides linguistic information such as a list of possible parts-of-speech, any available possible translations and any synonyms, etc.

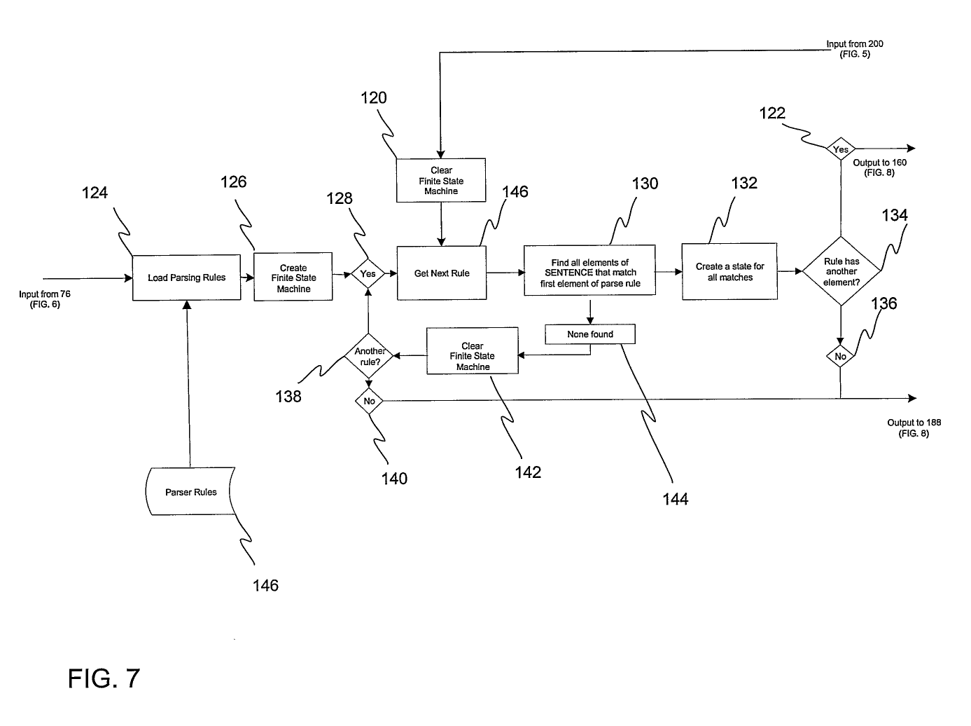

The SENTENCE data object is then updated in step 72 with the linguistic information for the current word. This information may include the tense, number, person, aspect, mood, and voice of verbs; the number of nouns, the comparative or superlative form of adjectives, etc. The current terminology candidate data object PHRASE is then updated with this information in step 74, since single words as well as multiwords can be considered as terminology candidates. If another word in the sentence needs to be analysed, as shown in step 80, the process returns in step 82 to load the next word in step 66. If the whole of the sentence has now been scanned, as shown in step 76, the process continues to the Phrase Parsing stage S4 of FIG. 7.

Root Forms

The root or base form is the uninflected form of a word. An inflection is a change in the form of a word (usually by adding a suffix or a change of a vowel or consonant) to indicate a change in its grammatical function. This change could be to denote person or tense. For a noun, the root form is the singular form e.g. box, candle. For a verb, the root form is the infinitive without “to” e.g. “to run” reduces to “run,” “climbed” reduces to “climb.” For an adjective the root form is the positive form e.g. rich, lovely (c.f. the comparatives “richer,” “lovelier” or the superlatives “richest,” “loveliest”). For an adverb, the root form is also the positive form, although in English, a regularly formed “-ly” adverb reduces to the positive form of the adjective from which it derives, e.g. “cheerfully” reduces to “cheerful,” “spotlessly” reduces to “spotless.”

Phrase Parsing Stage

The first step of the Phrase Parsing stage S4 of FIG. 4 is shown in step 124 of FIG. 7 and involves loading the parser rules, as shown by item 146. The parser rules instruct the software on how to scan or parse the source language elements of a sentence to pick out or extract terminology candidates. The parser scans across the source language elements of a sentence for an occurrence that fits one of the parser rules. The sentence is scanned for each of the rules in turn. For English source material, a parse rule is matched if one of the following sequences is detected:

Parse Rule 1: one verb followed by one preposition

Parse Rule 2: a base form adjective followed by a singular noun

Parse Rule 3: one or more singular nouns followed by a noun

Parse Rule 4: any compound containing a hyphen

Parse Rule 5: a capitalised noun, followed by a preposition, followed by zero or more adjectives, followed by one capitalised noun, followed by one or more capitalised nouns

Parse Rule 6: a capitalised word followed by one or more capitalised words

It should be noted that the Parse Rules are extensible. The five English rules listed above can be modified or added in the appropriate table in the lexical database without requiring the software to be recompiled.

It can be seen that Parse Rule 1 has two rule elements; a verb and a preposition, whereas Parse Rule 5 has at least four rule elements; a first capitalised noun, a preposition, a second capitalised noun and a third capitalised noun.

At the start of the parsing process, a Finite State Machine (FSM) is created, as shown in step 126, to keep track of the parse rule currently being scanned, as shown in step 128. For a first parse rule, as shown in step 146, the sentence is scanned for all source language elements that match the first rule element of a parse rule in step 130. The term “source language element” is used to denote single words, or multiwords, or other elements of a sentence. The term “rule element” is used to denote a part of the parse rule that a source language element must be matched to, the source language elements each having at least one piece of linguistic information attached to them. Referring to Parse Rule 1 for example, the first rule element here is a verb, so the parse rule will search through the sentence for verbs.

If no source language elements that match a parse rule are found, as shown in step 144, the FSM is cleared in step 142 and a decision as to whether there is another parse rule to be checked is made in step 138. If there are no more parse rules to be checked, as shown in step 140, the process moves on to write the matched terminology candidates to the PHRASE data object in step 188, which is described later.

If another parse rule does need to be scanned, as shown in step 128, a further rule is loaded in step 146 and the sentence is scanned for all source language elements that match this further rule in step 130 as before. Steps 144, 142, 138, 128, 146 and 130 are repeated in turn until all source language elements of the sentence that match the first rule element of the parse rule have been found. A state is then created in the FSM to keep track of each of the matches found in step 132. The parse rule is then checked again to see whether it has another rule element in step 134. Referring to Parse Rule 1 for example, the second rule element here is a preposition, so the parser will search through the sentence for prepositions that occur after verbs.

If there is no other rule element, then the process moves on to write the matched terminology candidates to the PHRASE data object in step 188, which is described later.

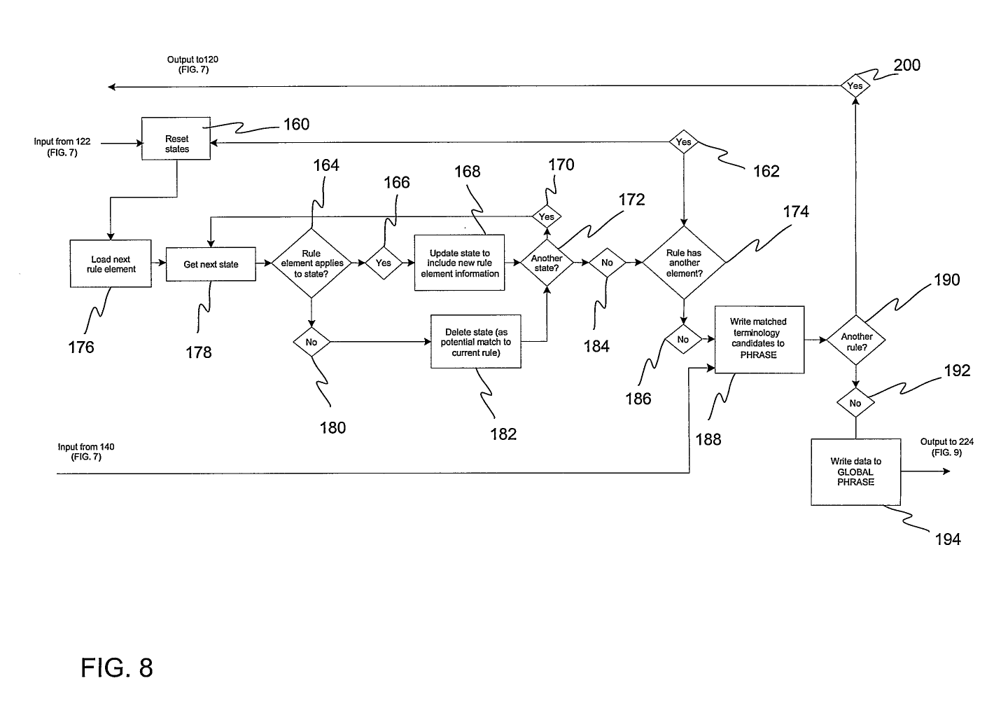

If there are more rule elements to the parse rule currently being scanned, as shown in step 122, all the states in the FSM are reset in step 160 of FIG. 8. The next rule element is then loaded in step 176 and the first state of the FSM is loaded in step 178. The current rule element is then checked to see whether it applies to this state in step 164.

If the current rule element does apply to the first state, as shown in step 166, this state is updated to include the current rule element information in step 168, i.e. the current state is a potential match to the current rule. In step 172, the parser checks to see if there is another state in the FSM to be analysed. If there is, as shown in step 170, the process returns to load the next state in step 178. The process then continues to check if there are more states in the FSM to be analysed from step 172.

If the current rule element does not apply to the first state, as shown in step 180, then the state is deleted in step 182 from the FSM as it cannot be a potential match to the current rule. The process then continues to check if there are more states in the FSM to be analysed from step 172.

If there are no more states in the FSM to be analysed, as shown in step 184, the current parse rule is checked to see if it contains another rule element in step 174. If there are more elements to the current parse rule, as shown in step 162, the states in the FSM are reset in step 160 and the next rule element is loaded in step 176. This process repeats as before until all the elements in the current rule have been analysed, as shown in step 186.

The matched terminology candidates are then written in step 188 to the PHRASE data object. The parser now checks to see if there are more parse rules to scan for matches in the source sentence, as shown in step 190. If another rule needs to be checked for in the source text, as shown in step 200, the process returns to clear the FSM in step 120. If there are no more rules to scan for, as shown in step 192, the data from the terminology candidates identified thus far is written in step 194 to the GLOBAL PHRASE data object. The process then moves on to the Export stage S5 of FIG. 4.

Example Sentence

A description of the processing of an example sentence for the Word Analysis and Phrase Parsing stages is now provided. The example sentence is “It was hidden under the sofa-bed.”

Starting from step 40 in FIG. 5, this sentence is sent to the Word Analysis stage S3. The relevant data objects are cleared in step 60 and the sentence is segmented into seven source language elements in step 62. The hyphenated compound “sofa-bed” is treated as two source language elements here, and the presence of the hyphen is noted in the SENTENCE data object during the punctuation information updating step 64.

The first source language element “it” is then loaded in step 66 and reduced to root form in step 68 by applying the inflection rules of item 84. The root form is then checked in step 70 by reference to the lexical database of item 86, and the singular pronoun is saved to the current sentence data object SENTENCE in the word information updating step 72. The current terminology candidate data object PHRASE is also updated in step 74.

The parser then checks to see if there is another source language element in the sentence in step 80. In this case there is, so step 82 is executed and the second source language element of the sentence “was” is loaded in step 66. The source language element “was” is from the verb infinitive “to be” so its root is “be.” Its use here is as a passive auxiliary (and hence a function word) to the verb following it and the current sentence data object SENTENCE is updated with this information in step 72. The current terminology candidate data object PHRASE is also updated in step 74 and the sentence is then checked to see if another source language element is present in step 80.

The third source language element of the sentence, “hidden” is then loaded in step 66. It is reduced to root form in step 68 and found to be the word “hide” of the verb infinitive “to hide.” This root form is then checked in step 70 in the lexical database of item 86 and the updates of steps 72 and 74 are made as before.

The fourth source language element “under” is a preposition and the fifth and sixth source language elements “sofa” and “bed” from the hyphenated compound “sofa-bed” are nouns and these are analysed in a manner similar to the first three source language elements of the sentence.

Once all the source language elements in the sentence have been analysed, the parser rules of item 146 are loaded in step 124 and the FSM is created in step 126. The first rule, Parse Rule 1, is loaded initially in step 146, which looks for one verb followed by one preposition. The sentence is scanned in step 130 for the first rule element of the parse rule i.e. a verb. The only verb found is “hide” in its root form, so one state is created in the FSM for this match in step 132. The rule is then checked for another element in step 134.

The rule does have another element, so step 122 is executed and the existing state is reset in step 160. The term “reset” here means that the state machine jumps back to the zeroth state in a standard operation for a FSM. In order to find a match with Parse Rule 1, the second rule element of Parse Rule 1 states that the next source language element must be a preposition, as shown in step 176. The required state is loaded in step 178 (i.e. the state machine jumps to the first state corresponding to the first match) and the rule element is checked to see if it applies to this state in step 164. The preposition “under” does indeed fit, so step 166 is executed and this state is updated to include a match also to the second element of this parse rule in step 168.

There are no more states to be analysed, so steps 184 and 172 are executed. Neither are there any more rule elements to the current parse rule, so steps 174 and 186 are executed and the matched terminology candidate “hidden under” is written to the current terminology candidate data object PHRASE in step 188.

A second parse rule does exist, so steps 190 and 200 are executed and the FSM is cleared in step 120 so that the sentence can be scanned for instances of this next parse rule in step 146. The process repeats as before, but there are no adjectives in the sentence, so no matches for Parse Rule 2. The third parse rule also is not matched, as there are no sequences of consecutive nouns. The fourth parse rule is, however, matched to the compound “sofa-bed” as it contains a hyphen and this is written to the current terminology candidate data object PHRASE in step 188. The fifth and sixth parse rules do not match to this sentence, so the terminology candidate parsing stage is completed for this sentence. The global terminology candidate data object GLOBAL PHRASE is then updated in step 194 with information on the terminology candidates extracted from the sentence.

Export Stage

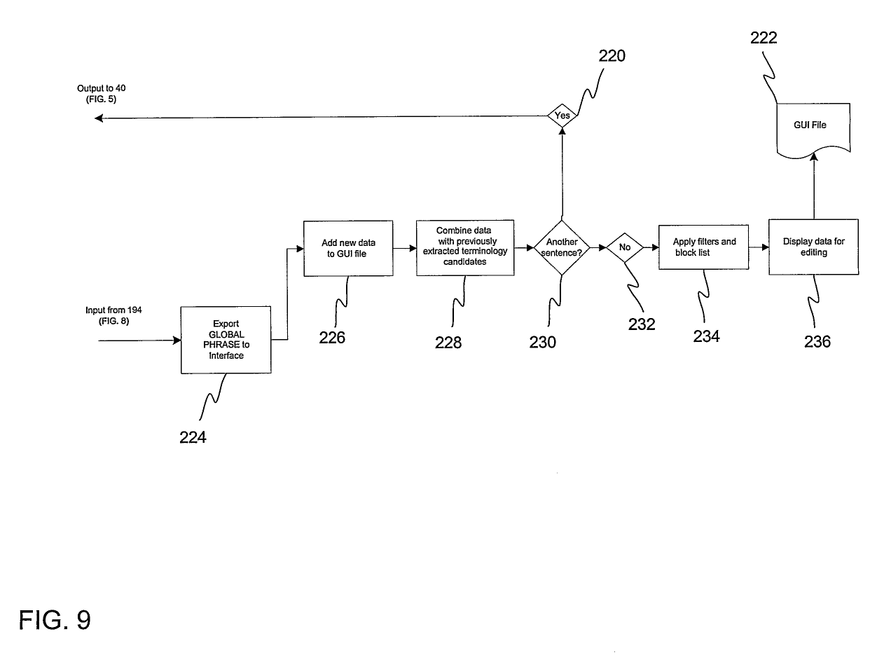

Returning now to the general discussion of the invention, once the terminology candidates from a sentence have been extracted, the Export stage S5 of FIG. 4 is reached. A more detailed view of this stage is shown in FIG. 9. The terminology candidates held in the GLOBAL PHRASE data object are written to an Interface file in step 224. The Interface file is in a format suitable to be read by the GUI software component. The data in the Interface file is then combined with data from any previous terminology candidate extractions and exported to the GUI in steps 226 and 228.

The software then checks to see if there are any more sentences to be analysed in step 230. If there are more sentences then step 230 is executed and the process jumps back to the next sentence loading step 40 of the Initial Setup stage S2.

If all of the text has been analysed then step 232 is executed and any filters and lists of blocked words are applied to the extracted terminology candidates list, as shown in step 234. This will remove any terminology candidates that are in the blocked word list, so that they are not presented to the linguist for editing and validation. Terminology candidates may be in the blocked word list for a variety of reasons; they may be nonsense terminology candidates (or noise) created from previous extraction runs; they may be terminology candidates that would unnecessarily take up large amounts of the computational linguist's time to edit or the translator's time to translate; they may be terminology candidates that could cause confusion or offence to a particular regional culture or dialect, or they may be terminology candidates that are unsuitable for a particular project etc.

The filters applied to the list of extracted terminology candidates could remove unwanted capitalisations, repeated similar terminology candidates or conflicting terminology candidates etc. Such filters could be language specific, region specific or application area specific.

Once the extracted terminology candidate data in the Interface file is ready for editing it is presented to the user by the GUI in a variety of ways, as shown in step 236.

FIG. 10 shows a screenshot of the root form view of a list of extracted terminology candidates, displayed by clicking the icon of item 376. The terminology candidates have been ordered by frequency of occurrence by clicking the icon of item 382 and in descending order by clicking the icon of item 388. In this particular screenshot, the cursor is clicked on the “accounting firm” terminology candidate of item 366. The row number here is “1,” the frequency is “1” and the rank is “8,” as shown by items 372, 362 and 364 respectively.

Ranking Function

The rank is a confidence-index value having a range of values, for example a set of values ranging from 1 to 10. The rank may be determined initially by the analysis of extracted terminology candidates from a large corpus by determining what percentage of the extracted terminology candidates that matched a particular parser rule are, in fact, semantically relevant. For example, an initial rank of eight may be assigned to a parser rule that is most likely to yield a good terminology candidate. The initial rank may then be increased based on the frequency of occurrence of a given extracted terminology candidate in the source material.

So, when for example, Terminology Candidate A is first found in a document, it may be given an initial rank according to the terminology candidate pattern that it matched on (say for example it matched Rule A, which has a rank of 7). With each subsequent occurrence of Terminology Candidate A in the source material, however, the rank will potentially increase. The user is presented with a list of terminology candidates with their raw number of occurrences in the source material and the rank (as mentioned above, a function of pattern confidence and frequency of occurrence). By ordering terminology candidates according to their ranking, the user can focus their work on the extracted terminology candidates that are most likely to be semantic units. If a terminology candidate was found only once but has an initial ranking of 8, it is a good candidate. A terminology candidate that receives a low initial rank might then be increased to a rank of 8 based on its frequency of occurrence. Both of these situations warrant the attention of the user. The default settings for the initial rankings can be adjusted by the user of the software, i.e. the computational linguist.

Various statistical metrics could be used when analysing the large corpus to produce initial rank estimates. This process should have some human input in order to review the quality of extracted terminology candidates for each pattern and hence arrive at reasonable estimates.

Returning now to the export stage discussion, the context window shows the sentences in which the terminology candidate appears. In this case the sentence only appears once and the terminology candidate appears as the inflected form “accounting firms” as shown by item 370. This terminology candidate is identified in the Part-of-Speech window of item 374 to be a noun phrase.

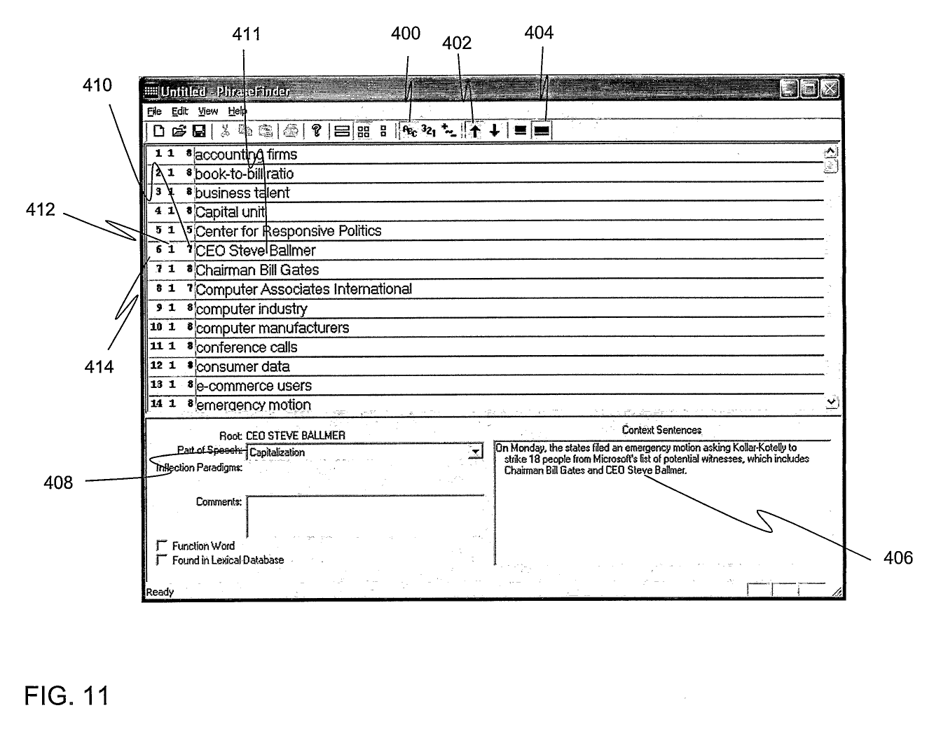

A screenshot of the same terminology candidates in inflected-form view is shown in FIG. 11. The terminology candidates have been displayed alphabetically by clicking on the icon of item 400 and displayed in ascending order by clicking on the icon of item 402. In this particular case, the cursor is clicked on the “CEO Steve Ballmer” terminology candidate of item 411 with row number “6” shown by item 414, frequency “1” shown by item 412 and rank “7” shown by item 410. The terminology candidate is highlighted in the context window in the sentence where it occurs, as shown by item 406, and the terminology candidate is identified in the Part-of-Speech window, as shown by item 408, to be a capitalisation.

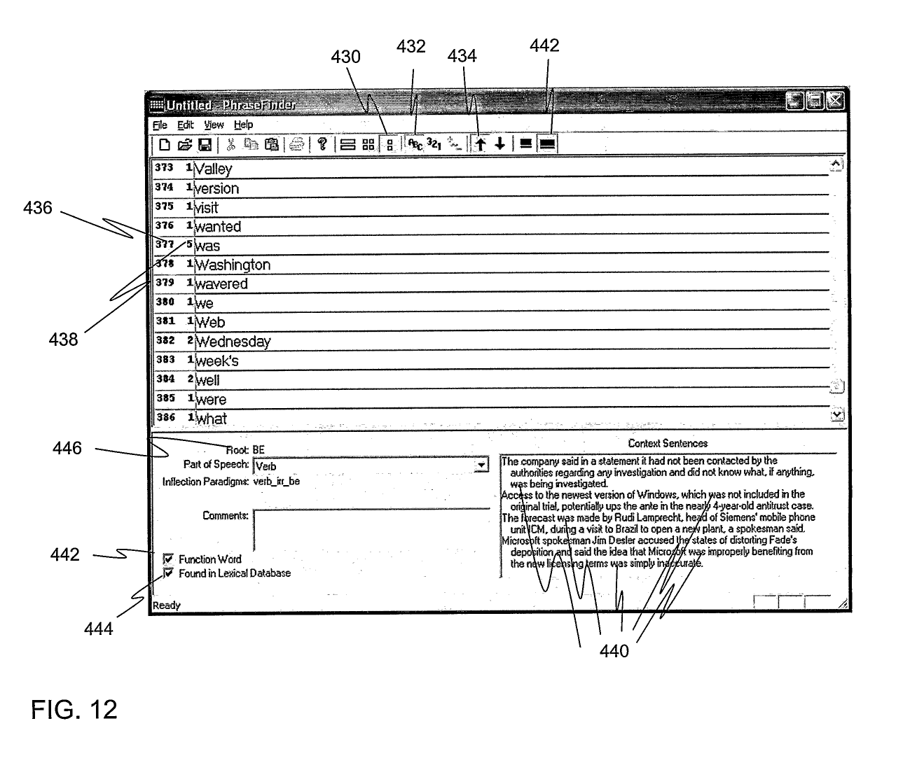

The screenshot of FIG. 12 shows an inflected word view, which has been displayed by clicking on the inflected form icon of item 442 and the word form icon of item 430. The words have been ordered alphabetically in ascending order by clicking on the icons of items 432 and 434. The concordance or word display mode is a list or index of all the words from the source text with any corresponding linguistic information. The word “was” has a row number of “377” as shown by item 436, and a frequency of occurrence of “5” as shown by item 438. The sentences where the word occurs in the source text are listed in the context window, as shown by item 440. The word “was” was identified as a function word, as shown by the checked box of item 442. It was found in the lexical database, as shown by the checked box of item 444. Its root form “BE” is indicated by item 446.

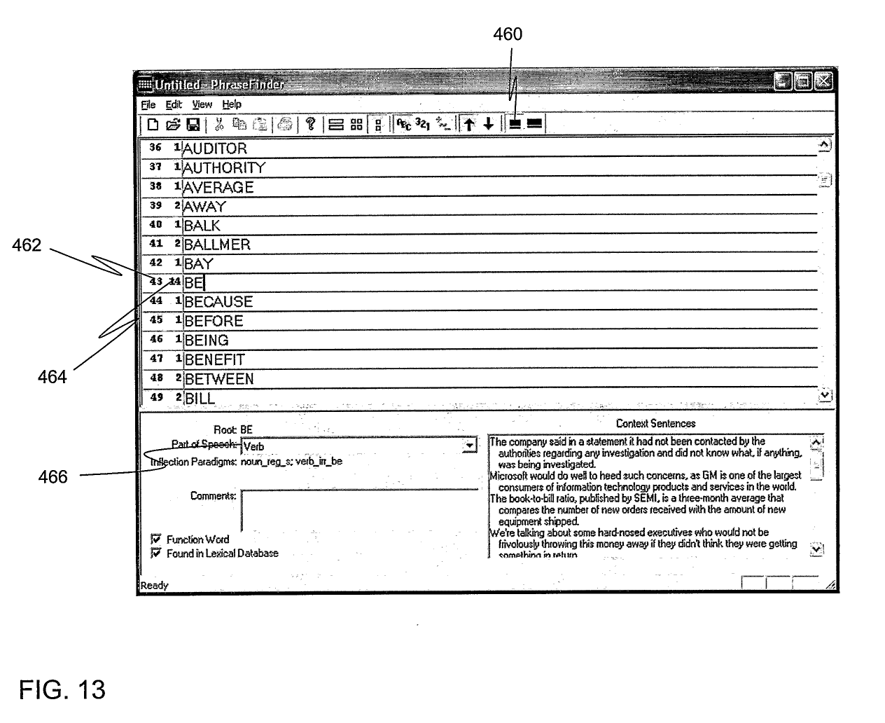

The display is switched from inflected to root form view by clicking on the icon of item 460 in the screenshot of FIG. 13. The word “was” is recognised as being of the verb part-of-speech, as shown by item 466, and comes from the verb infinitive “to be” so the root form is “be” of which the frequency is “14” as shown by item 464. There are more occurrences here than for “was” in the previous figure, as several words may have the same root form. The difference in the context window here is that, although the context sentences are listed, the word “be” is not highlighted because the original source sentences contain the inflected forms e.g. “was” or “are” or “is” etc. The row number has also changed to “43” due to the different ordering, as shown by item 462.

It should be noted that the computational linguist or other user can override any of the linguistic details here if it is felt that a source language element or terminology candidate has been incorrectly identified during the extraction process or would be better classified differently. This overriding may for example include changing the part-of-speech or removing the source language element from the list of function words.

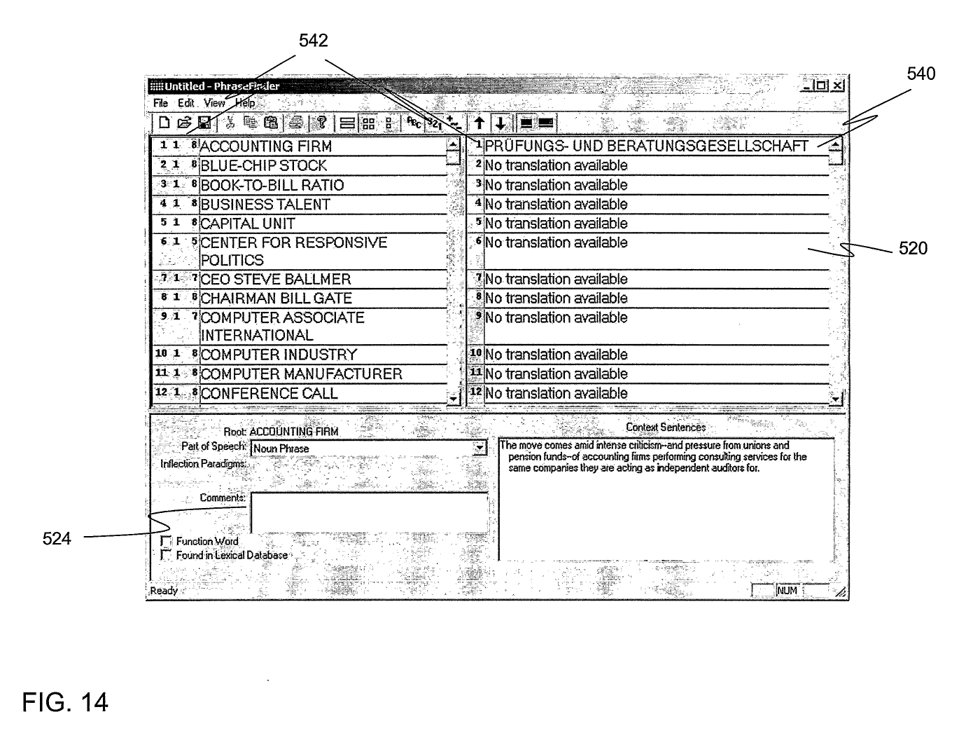

FIG. 14 shows a screenshot of some terminology candidates, with a second window, shown as item 520, for displaying translations of these terminology candidates. This display mode is produced when the option to display translations is chosen in the user settings. The user is able to edit any translated terminology and provide their own translations, as shown by item 540 or add comments to any terminology candidate, as shown by item 524.

By using the edit menu or right-clicking the mouse over a terminology candidate, the user can validate the terminology candidate to show that it has been reviewed. For the first terminology candidate in the screenshot of FIG. 14, a translation has been provided and the terminology candidate has been validated, denoted by the change in colour around the row numbers, as shown by item 542.

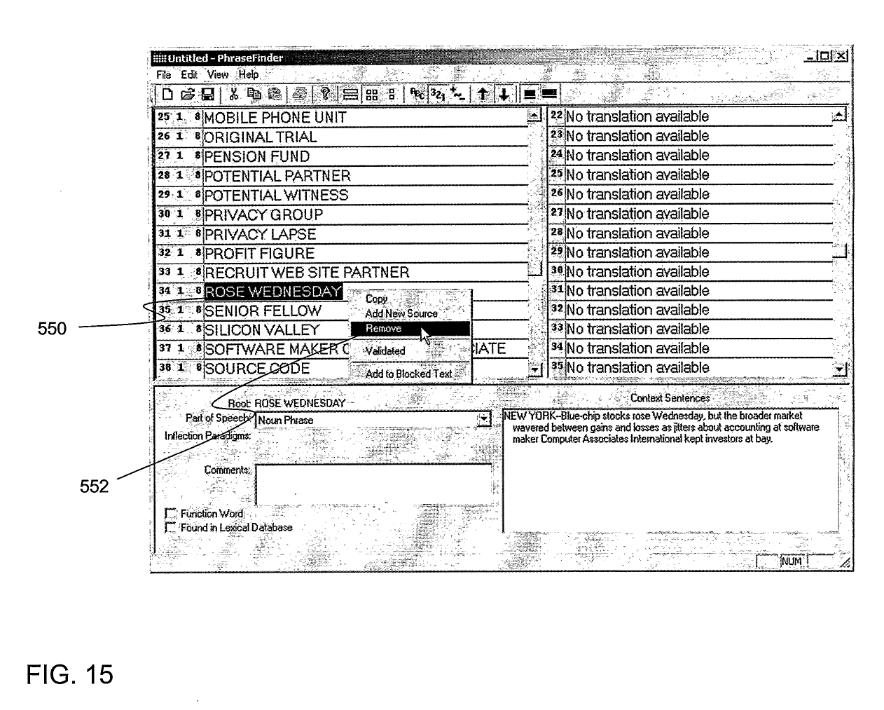

Bad terminology candidates or noise can be removed from the list of terminology candidates by right clicking or using the edit menu. FIG. 15 shows such an example for the removal of the bad terminology candidate “ROSE WEDNESDAY” as shown by items 550 and 552.

Once the user considers the terminology candidate list and/or the corresponding translations to be sufficiently developed, the user can choose to export into a number of file formats. There are options for exporting the terminology candidates only, the source language elements only or both the source language elements and terminology candidates; and the validated terminology only, the terminology candidates only, or both the validated terminology and terminology candidates. There are also options to return a specified number of the best ranking matches, a specified number of the most frequent matches or not to limit to best matches.

The above embodiments are to be understood as illustrative examples of the invention. The six parse rules listed in the Phrase Parsing stage section are not to be taken as the only possible parse rules. The present invention is designed to be extensible such that these parse rules can be complemented by additional parse rules with different language constructions created, for example by computational linguists or translators, and does not require a recompiling of the software.

The above description covers the invention for the English language as the source language so that the parse rules and associated grammatical discussion are tailored towards the English language. Clearly, the present invention also applies to other natural languages, but the specifics for each and every other language cannot be covered here. For these other natural languages, there are different sets of corresponding parse rules and grammatical principles that have not been discussed herein. There are also different methods for finding the root forms of words in other languages e.g. there are tenses in the Spanish language such as the subjunctive that do not have a true equivalent in English, but which are nonetheless covered by the present invention for languages other than English. The breakdown of Germanic compound words into individual words is also covered by the present invention, but not discussed in the preceding discussion. Other such modifications exist for many of the other languages covered by the present invention.

The part-of-speech mentioned in the preceding description are the main English part-of-speech such as nouns, verbs etc. These parts-of-speech can be subdivided into further parts such as gerunds, auxiliaries, modals, articles etc. As well as including these for the English language, the present invention has the scope to include these and any number of equivalent and extra parts from natural languages other than English.

Further embodiments of the invention are envisaged. The present invention has only been described in relation to monolingual terminology candidate extraction. Another embodiment involves applying the present invention to aligned bilingual texts, whereby the terminology candidate extraction process is carried out for each of the texts in their natural languages. This can be used for the automated generation of glossaries or dictionaries, which can then be used in the translation of further text.

When processing aligned bilingual texts, translations of the extracted terminology candidates and also synonyms and translations of these synonyms are used between the terminology candidate parsing and exporting stages as this may help to deal with the different word ordering or other structural and/or grammatical differences between the two or more natural languages involved. It may also help with the matching of the words and terminology candidates extracted from the text in one natural language to those extracted from the text in the other natural language. Here the alignment of the sentences as well as the extracted terminology candidates themselves are utilised by the present invention.

The above description of the present invention showed some of its functionality via use of a software application running on a single workstation computer. This is to be taken as just an example of a platform on which the present invention could be implemented and could also be operated on other suitable platforms, either remotely or locally to the user.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A computer-implemented method for use in natural language translation, said method comprising performing, in a software process, the steps of:
a) selecting at least a part of source materials in a first natural language;
b) selecting a first source language element from said part;
c) selecting a second, different, source language element from said part;
d) attaching at least a first piece of linguistic information to said first source language element;
e) attaching at least a second piece of linguistic information to said second source language element;
f) matching said first and second pieces of linguistic information to at least a first parse rule;
g) forming an association between said first and second source language elements in response to said matching to create a first terminology candidate; and
h) outputting said first terminology candidate in a form suitable for review by a human reviewer prior to full translation of said source materials in said first natural language to at least a second natural language.

2. A method according to claim 1, wherein said first piece of linguistic information is part-of-speech information.

3. A method according to claim 1, wherein said second piece of linguistic information is part-of-speech information.

4. A method according to claim 2, wherein said first and/or said second piece of linguistic information indicates that the respective source language element is one or more of a verb, a noun, an adjective, an adverb, a conjunction, a determiner, an interjection, a pronoun, a preposition or a quantifier.

5. A method according to claim 4, wherein said first piece of linguistic information indicates a verb part-of-speech, said second piece of linguistic information indicates a preposition part-of-speech and said first parse rule requires said first source language element to be followed by said second source language element in said part.

6. A method according to claim 4, wherein said first piece of linguistic information indicates a base form adjective part-of-speech, said second piece of linguistic information indicates a singular noun part-of-speech and said first parse rule requires said first source language element to be followed by said second source language element in said part.

7. A method according to claim 4, further comprising performing, in a software process, the steps of:
i) selecting one or more, further, source language elements from said part; and
j) attaching one or more, further, pieces of linguistic information to said further source language elements,
wherein said first and one or more, further, pieces of linguistic information indicate a singular noun part-of-speech, said second piece of linguistic information indicates a noun part-of-speech, and said first parse rule requires said first source language element to be followed by said one or more, further, source language elements, to in turn be followed by said second source language element in said part.

8. A method according to claim 4, further comprising performing, in a software process, the steps of:
i) selecting third and fourth, different, source language elements from said part; and
j) attaching at least third and fourth pieces of linguistic information to said third and fourth source language elements respectively;
wherein said first, third and fourth pieces of linguistic information indicate a noun part-of-speech, said second piece of linguistic information indicates a preposition part-of-speech, and said first parse rule requires said first, second, third and fourth source language elements to follow in succession in said part.

9. A method according to claim 8, further comprising performing, in a software process, the steps of:
k) selecting one or more, further, source language elements from said part; and
1) attaching one or more, further, pieces of linguistic information to said one or more, further, source language elements,
wherein said one or more, further, pieces of linguistic information indicate an adjective part-of-speech and said first parse rule requires said first, second, one or more, further, third and fourth source language elements to follow in succession in said part.

10. A method according to claim 1, wherein one or more of said source language elements are single words.

11. A method according to claim 1, wherein one or more of said source language elements are concatenations of at least two words.

12. A method according to claim 1, further comprising performing, in a software process, the step of counting the frequency of occurrence of each source language element.

13. A method according to claim 1, further comprising performing, in a software process, the step of counting the frequency of occurrence of each terminology candidate.

14. A method according to claim 1, further comprising performing, in a software process, the step of filtering the source language elements to remove at least one source language element or terminology candidate contained in a previously ascertained block list.

15. A method according to claim 1, wherein said first terminology candidate output by at least said first parse rule is used as the first or second source language element input for at least a second parse rule.

16. A method according to claim 1, further comprising performing, in a software process, the step of creating at least one terminology candidate/translated terminology pair by converting said first terminology candidate into a corresponding first translated terminology in a second, different, natural language.

17. A method according to claim 1, wherein said conversion involves validation by a user.

18. Computer software arranged to perform the steps according to claim 1.

19. Apparatus for computer assisted natural language translation comprising:
an information storage system adapted to store digital content, said content including source materials in a first natural language, a plurality of pieces of linguistic information and their associations to source language elements, a plurality of parse rules, a plurality of terminology candidates, a set of validated terminology and a set of translated terminology;
an information processing system adapted to provide a means for determining instances of source language elements, executing parse rules and the process of attaching pieces of linguistic information to source language elements;
a data entry system adapted to provide a means for entering selection data relating to said content, wherein said selection data includes data indicating the validation of terminology candidates; and
a visual display system adapted to present information from the information storage system, said presentation information including data in the form of said source materials, said source language elements, said plurality of terminology candidates, said set of validated terminology and said set of translated terminology.

20. A computer-implemented method for use in natural language translation, said method comprising performing, in a software process, the steps of:
a) selecting at least a part of source materials in a first natural language;
b) selecting a first source language element from said part;
c) selecting a second, different, source language element from said part;
d) matching said first and second source language elements to at least a first parse rule, said first parse rule requiring said first and/or second source language elements to have a predetermined characteristic;
e) forming an association between said first and second source language elements in response to said matching to create a first terminology candidate; and
f) outputting said first terminology candidate in a form suitable for review by a human reviewer prior to full translation of said source materials in said first natural language to at least a second natural language.

21. A method according to claim 20, further comprising performing, in a software process, the steps of:
f) selecting a third, different, source language element from said part;
g) matching said third source language element to at least said first parse rule, said first parse rule requiring said first and/or second and/or third source language elements to have a predetermined characteristic;
h) forming an association between said first, second and third source language elements in response to said matching to create a second terminology candidate; and
i) outputting said second terminology candidate in a form suitable for review by a human reviewer prior to full translation of said source materials in said first natural language to at least a second natural language.

22. A method according to claim 20, wherein said predetermined characteristic is a capitalization.

23. A method according to claim 20, wherein said predetermined characteristic is a hyphen.

24. A computer-assisted method for use in natural language translation, said method comprising performing, in a software process, the steps of:
a) identifying a set of terminology candidates in at least a part of source materials in a first natural language;
b) presenting said set of terminology candidates to a user via a user interface; and
c) receiving selection data from said user, said selection data being used to create a subset of said terminology candidates to generate a set of validated terminology.

25. A method according to claim 24, wherein said identification comprises the steps of:
storing a list of terminology candidates to be blocked from said presentation;
checking said identified terminology candidates against said list of blocked terminology candidates; and
blocking at least one identified terminology candidate from said presentation.

26. A method according to claim 25, further comprising the step of receiving further selection data from said user, said further selection data being used to add at least one terminology candidate to said block list.

27. A method according to claim 24, further comprising performing, in a software process, the step of initially determining a rank of one or more terminology candidates according to a historical analysis of previously identified terminology candidates.

28. A method according to claim 24, further comprising performing, in a software process, the step of subsequently updating a rank of one or more terminology candidates according to the frequency of occurrence of said one or more terminology candidates in said source text.

29. A method according to claim 24, further comprising performing, in a software process, the step of presenting two or more terminology candidates in an order dependent on a rank of said two or more terminology candidates.

30. A method according to claim 24, further comprising performing, in a software process, the step of exporting said validated terminology into a database for use in future translations.

31. A computer-implemented method for use in natural language translation, said method comprising performing, in a software process, the steps of:
a) loading at least a part of source materials in a first natural language;
b) selecting a first parse rule;
c) using said first parse rule to identify one or more terminology candidates in said part;
d) outputting said one or more identified terminology candidates;
e) selecting a second parse rule;
f) using said second parse rule to identify one or more further terminology candidates in said part; and
g) outputting said one or more further identified terminology candidates.

32. A method according to claim 31, further comprising performing, in a software process, the steps of loading one or more, further, parse rules and repeating above selecting, using and outputting steps one or more times in succession to produce one or more still further terminology candidates.

33. A method according to claim 31, wherein one or more of the output terminology candidates are used as one or more of the inputs to one or more of the parse rules.

34. A method according to claim 31, wherein said parse rules are stored as a set of extensible parse rules.

35. A computer-implemented method for use in natural language translation, said method comprising performing, in a software process, the steps of:
a) selecting at least a part of source materials in a first natural language;
b) selecting a first source language element from said part;
c) selecting a second, different, source language element from said part;
d) attaching at least a first piece of linguistic information to said first source language element;
e) attaching at least a second piece of linguistic information to said second source language element;
f) analyzing said first and second pieces of linguistic information to determine whether said first and second source language elements are likely to be an item of terminology; and
g) if so, forming an association between said first and second source language elements to create a first terminology candidate.
